(19) United States
(12) Patent Application Publication
(10) Pub. No.: US 2021/0285423 A1
(43) Pub. Date: Sep. 16, 2021

(54) TOWER STRUCTURE, WIND TURBINE AND METHOD FOR ASCERTAINING OPERATING LOADS AND FOR DESIGNING TOWER STRUCTURES

(71) Applicant: Wobben Properties GmbH

(72) Inventors: Bernd Boettcher, Aurich (DE); Jens Bücker, Bremen (DE); Milan Damminger, Bremen (DE)

(21) Appl. No.: 16/332,745

(22) PCT Filed: Sep. 14, 2017
(86) PCT No.: PCT/EP2017/073116

§ 371 Date: Mar. 12, 2019

(30) Foreign Application Priority Data
Sep. 15, 2016 (DE) 10 2016 117 402.5

(51) Int. Cl. F03D 17/00; F03D 13/20

(52) U.S. Cl. CPC F03D 17/00; F03D 13/20; F05B 2270/32; F05B 2200/11; F05B 2270/331; F05B 2240/912; F05B 2200/14; F05B 2270/321

(57) ABSTRACT

A method for establishing operating loads, in particular wind loads, for tower structures, in particular for tower structures for wind power installations is provided. Provided is a method for designing a tower structure, in particular a tower structure for a wind power installation, a method for determining the service life of a tower structure, in particular a tower structure for a wind power installation, and a tower structure, in particular a tower structure for a wind power installation, and a wind power installation. The method for establishing operating loads for tower structures comprises establishing a load parameter in a load direction, establishing a load direction occurrence distribution, establishing a load parameter modified by the load direction distribution.

### BACKGROUND

### Technical Field

The invention relates to a method for establishing operating loads, in particular wind loads, for tower structures, in particular for tower structures for wind power installations. The invention further relates to a method for designing a tower structure, in particular a tower structure for a wind power installation, a method for determining the service life of a tower structure, in particular a tower structure for a wind power installation, and a tower structure, in particular a tower structure for a wind power installation, and a wind power installation.

### Description of the Related Art

As a rule, establishing operating loads represents part of designing a tower structure, or precedes this. By way of example, operating loads can be wind loads. In particular, operating loads are time varying, changing loads, which may lead to fatigue loading of tower structures. The higher the operating loads established for a tower structure, the more resilient the design of the tower structure must be in order to withstand the operating loads over the planned service life, in particular also in view of fatigue loading.

Existing methods for establishing operating loads try to establish the operating loads as accurately as possible in order to avoid over-dimensioning of the tower structures within the scope of the design process. However, further improvements are desirable.

In the priority application for the present application, the German Patent and Trade Mark Office has searched the following prior art: U.S. Pat. No. 6,850,821 B2 and US 2013/0125632 A1.

### BRIEF SUMMARY

Provided is a method for establishing operating loads, in particular wind loads, for tower structures, in particular for tower structures for wind power installations. Provided is a method for designing a tower structure, in particular a tower structure for a wind power installation, a method for determining the service life of a tower structure, in particular a tower structure for a wind power installation, and a tower structure, in particular a tower structure for a wind power installation, and a wind power installation, which are improved in relation to existing solutions. In particular, provide is a method for establishing operating loads, in particular wind loads, for tower structures, in particular for tower structures for wind power installations, which facilitates a more advantageous design of tower structures and/or a lengthened service life of tower structures.

Provided is a method for establishing operating loads, in particular wind loads, for tower structures, in particular for tower structures for wind power installations, comprising establishing a load parameter in a load direction, establishing a load direction occurrence distribution, establishing a load parameter modified by the load direction distribution.

A load parameter is established in a load direction in the case of existing methods for establishing operating loads, said load direction usually corresponding to a main load direction. The tower structure is designed for this load parameter. However, this may lead to over-dimensioning, particularly in the case of direction-dependent load parameters, since a variance of the load over various load directions remains unaccounted for.

Load parameters in the form of wind loads play a large role, particularly in the case of tower structures of wind power installations. By way of example, when developing a wind power installation, the respective components, such as tower structures, for example, of the wind power installation are designed, as a rule, in such a way that operation of the wind power installation for the envisaged service life is possible. By way of example, the service life of a wind power installation can be 20, 25 or 30 years.

A wind power installation and the components thereof are exposed to stationary and non-stationary loads. By way of example, the non-stationary loads can be caused by wind turbulences, oblique incoming flows and a height profile of the wind speed. Hence, the load spectrum acting on the wind power installation is multifaceted and the respective load situations are preferably evaluated in the entirety thereof. As a rule, this is implemented by a load spectrum, which represents the sum of the load situations. The non-stationary loads acting on the wind power installation can lead to fatigue of the components of the wind power installation. Therefore, each component of the wind power installation is preferably designed in such a way that failure-critical fatigue only occurs when reaching, or after reaching, the service life of the wind power installation.

Preferably, a main load direction in the form of a main wind direction is established for the planned location of a wind power installation and a load parameter in the form of a wind load is established for this main load direction. However, the fact that the wind load varies over various directions, namely also over secondary load directions in addition to the main load direction, remains unconsidered here.

Taking account of the load direction occurrence distribution is proposed. In particular, this can be understood to mean taking account of how frequently, or with what probability, the load occurs in the main load direction and how frequently, or with what probability, the load occurs in a secondary load direction. This renders it possible to modify the load parameter in such a way that it does this load direction occurrence distribution justice. As a rule, this leads to the modified load parameter being smaller than the original load parameter since the original load parameter is based on the load being present only in the main load direction. It is consequently possible to obtain a more expedient design of a tower structure by taking account of the load direction occurrence distribution and by establishing a correspondingly modified load parameter.

The load directions can be subdivided as desired. By way of example, a load direction can be defined as one degree. Finer or coarser definitions of the load direction are likewise possible. By way of example, a load direction may also be defined as a segment of 10 degrees, for example.

By way of example, a load parameter can be a wind load. By way of example, a load parameter can be specified as a range of torque. A load parameter can also be specified in the form of torques, transverse forces and/or stresses. Combinations of different parameters are also possible.

In particular, wind loads are dynamic vibrations that lead to time varying, changing loads which, in turn, lead to fatigue loading. Preferably, the load parameter is a load spectrum. By way of example, the load parameter can contain load transitions.

Preferably, load parameters can be established by simulation, for example depending on the planned location of the tower structure and the loads to be expected there. Historical and/or measured load data can also be used for establishing the load parameter. Prefer-ably, wind speeds and/or wind averages (mean wind speeds) and/or further location-specific parameters are used to establish a wind load parameter.

Preferably, a load direction in which the load parameter is established is set first. As a rule, this load direction corresponds to the main load direction; in wind power installations, this preferably corresponds to the main wind direction.

According to a preferred embodiment, provision is made for there to be a split of the load parameter according to the load direction occurrence distribution into load parameter components in different load directions. Further, there preferably is a summation of the load parameter components per load direction.

What this can achieve is that a load originally established in a main load direction is reduced by the components occurring in one or more secondary load directions. At the same time, those components in the main load direction emerging from splitting the load established for one or more secondary load directions into different load directions are added to the reduced value.

Further, provision is preferably made for the load direction occurrence distribution to be estimated and/or to be established on the basis of historical and/or measured load data and/or to be established on the basis of a statistical distribution and/or an occurrence probability.

A preferred development is distinguished in that a probability mass function underlies the load direction occurrence distribution. By way of example, this can be a normal distribution (Gaussian distribution).

A further preferred development is characterized by establishing an occurrence distribution of the respective load direction for different load directions, wherein the distributions for different load directions are preferably the same or different.

In this development, provision is made for the fact that different distributions may be applicable to different load directions is taken into account. By way of example, the distribution for a main wind direction can look different to the distribution in a secondary wind direction that deviates from the main wind direction. Further, the same distributions may also be used for various wind directions.

Further, establishing a load parameter in different load directions is preferred. While the load parameter established for a load direction, preferably the main load direction, may also be used for the other load directions in a simple variant, provision is made in this embodiment for a load parameter to be established for various load directions and, consequently, for the load parameters to be able to vary in different load directions.

Preferably, each load parameter according to the occurrence distribution of the respective load direction is divided into load parameter components in different load directions. Further preferably, the respective load parameter components are summed per load direction.

Further, provision is made in a preferred embodiment for differences in relation to the different load directions to be taken into account when establishing a load parameter in different load directions. By way of example, this renders it possible to take account of the fact that different values of the load parameters arise for different load directions.

Preferably, differences in the form of different values of the load parameter in different load directions are taken into account.

Further, differences in the form of a distribution of the values of the load parameter, in particular over the circumference of the tower structure, are preferably taken into account. Preferably, the distribution is based on a probability mass function. By way of example, this can be a normal distribution (Gaussian distribution).

According to a further preferred embodiment, provision is made for differences in the form of different wind speeds in different load directions to be taken into account. By way of example, the (mean) wind speed, which can also be referred to as wind average, may be different in the main wind direction than in a secondary wind direction.

According to a further aspect, the object set forth at the outset is achieved by a method for designing a tower structure, in particular a tower structure for a wind power installation, comprising establishing an operating load for the tower structure according to an above-described method, designing the tower structure according to the established operating load. Designing the tower structure, which is also referred to as dimensioning or calculating the latter, is consequently preferably carried out according to the operating load established.

According to a further aspect, the object set forth at the outset is achieved by a method for determining the service life of a tower structure, in particular a tower structure for a wind power installation, comprising establishing an operating load for the tower structure according to an above-described method, establishing the service life of the tower structure according to the established operating load.

According to a further aspect, the object set forth at the outset is achieved by a tower structure, in particular a tower structure for a wind power installation, characterized in that a load parameter for designing the tower structure was established according to an above-described method and/or the tower structure was designed ac-cording to an above-described method.

According to a further aspect, the object set forth at the outset is achieved by a wind power installation comprising a tower and a nacelle arranged on the tower, said nacelle having a rotor with at least one rotor blade, characterized in that the tower is an above-described tower structure.

Regarding the advantages, embodiment variants and embodiment details of these further aspects of the invention and their respective developments, reference is made to the preceding description relating to the corresponding method features.

### BRIEF DESCRIPTION OF THE SEVERAL VIEWS OF THE DRAWINGS

Preferred embodiments of the invention are described in exemplary fashion on the basis of the attached figures. In detail,

FIG. 1 shows a schematic illustration of a wind power installation;

FIG. 2 shows a flowchart of a method for establishing operating loads for tower structures;

FIG. 3 shows load parameters in the form of load spectra for a tower structure illustrated in cross section;

FIG. 4A shows the upper load spectrum M90 and the lower load spectrum M0 from FIG. 3;

FIG. 4B shows a load direction occurrence distribution according to FIG. 4A;

FIG. 5 shows the same occurrence distributions for different load directions;

FIG. 6 shows a modified load parameter in the form of a modified spectrum level; and

FIG. 7 shows the upper load spectrum M90 and the lower load spectrum M0 according to FIG. 4A and, additionally, the modified load spectra M90′ and M0′.

### DETAILED DESCRIPTION

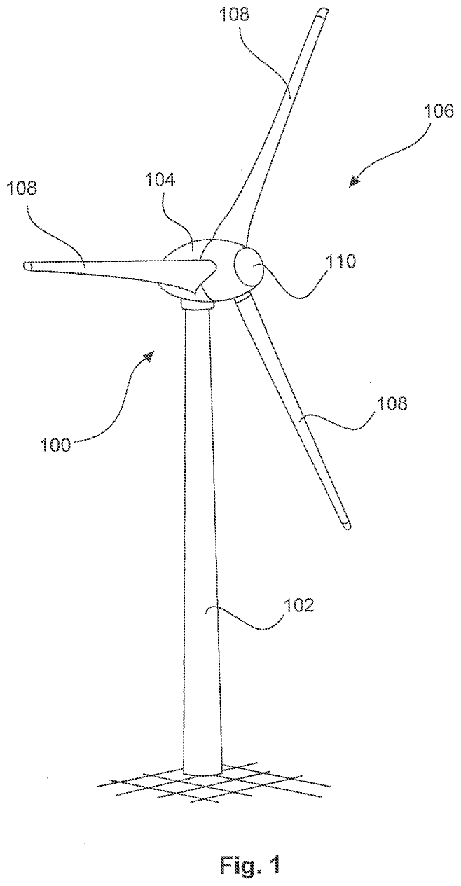

FIG. 1 shows a wind power installation 100 with a tower 102 and a nacelle 104. A rotor 106 with three rotor blades 108 and a spinner 110 is arranged on the nacelle 104. During operation, the rotor 106 is made to rotate by the wind and, as a result thereof, drives a generator in the nacelle 104.

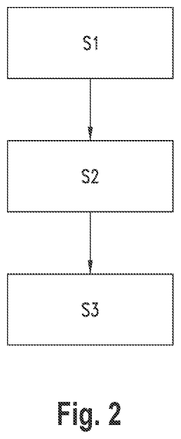

FIG. 2 shows a flowchart of a method for establishing operating loads for tower structures, in which a load parameter in a load direction is established in step S1, for example by simulation. A load direction occurrence distribution is established in step S2, for example by assuming a suitable probability mass function or probability density function, such as a normal distribution, for example. A load parameter that was modified by the load direction distribution is established in step S3.

Tower structures of wind power installations, in particular, are subject to fatigue load by time varying, changing loads as a result of the operation of the wind power installation. Therefore, as a rule, load spectra are established for the purposes of designing the tower structures; as a rule, this is implemented by a simulation. By way of example, different wind fields, installation resistances and/or a closed-loop control with a rotor blade adjustment can be taken into account in such a simulation. Since, as a rule, such a simulation is implemented for the main wind direction but the wind direction varies during the real operation of the installation and the rotor correspondingly tracks the wind by way of an azimuth adjustment of the nacelle, provision is made for this aspect to be taken into account. By way of example, the assumption is made here that the load, such as the wind, for example, acts on the tower structure from different directions according to a describable random distribution throughout the service life of the tower structure. In the following examples, this random distribution is illustrated by the application of the Gaussian normal distribution. As an alternative or in addition thereto, the distribution can be determined or estimated, for example by wind measurements and/or recorded closed-loop control data.

By way of example, load spectra for the design service life can be established when establishing the load parameter in the simulation. While existing design methods implement the design to counter the load spectrum of the main load direction under the assumption that this load acts from the main load direction over the entire planned service life, the method provides for the load occurrence distribution over different load directions to be taken into account. A probability mass density, for example described over the circumference of the tower structure, is preferably used for this distribution. In so doing, the highest probability is preferably assigned to the main load direction. By way of example, levels of a load spectrum of the main load direction can be distributed over the circumference or a part of the circumference (depending on the probability mass density), depending on the probabilities over the circumference of the tower structure. Preferably, the other load spectra of the other load directions are likewise distributed over the circumference of the tower structure. Each load spectrum can be a stationary load spectrum for a certain load direction.

Preferably, this procedure not only reduces the load spectrum of the main load direction but also complements the latter by those components of the load spectra of the secondary load directions that should be assigned to the main load direction on account of the distribution. As a result of this modification of the load parameter, a reduction of 25%, for example, can be achieved in the operating loads in the main load direction, which is relevant for the design. As a rule, the load spectra of the secondary load directions increase at the same time, possibly leading to a reduction in the difference of the load variation and/or a homogenization of the load level.

The procedure consequently renders it possible to take account of lower loads for new tower structures during the design thereof, which may lead to a more cost-effective and/or resources-sparing construction.

The procedure also renders it possible to substantiate a longer service life for existing tower structures. To this end, the operating load is established and the service life of the tower structure is substantiated for the established operating load, preferably taking account of the implemented design of the tower structure, in particular its dimensions and/or its structure. Here, a service life also can be understood to mean, in particular, a residual service life of tower structures that are already in service. To this end, it is possible to use the operating loads originally established for the design of the tower structure, for example in a simulation, and these can be modified using the method. As an alternative or in addition thereto, it is also possible to take account of measurement data from wind measurements and/or operational data of the wind power installation.

Further, it is preferable also to take account of the variance of the wind speed over the load directions. As a rule, the considered wind average also affects the load spectra in addition to the load direction. By virtue of a probability mass distribution of the wind speeds being applied over the circumference of the tower structure in the preferred configuration, further repositioning and hence reductions in the operating loads may be obtainable.

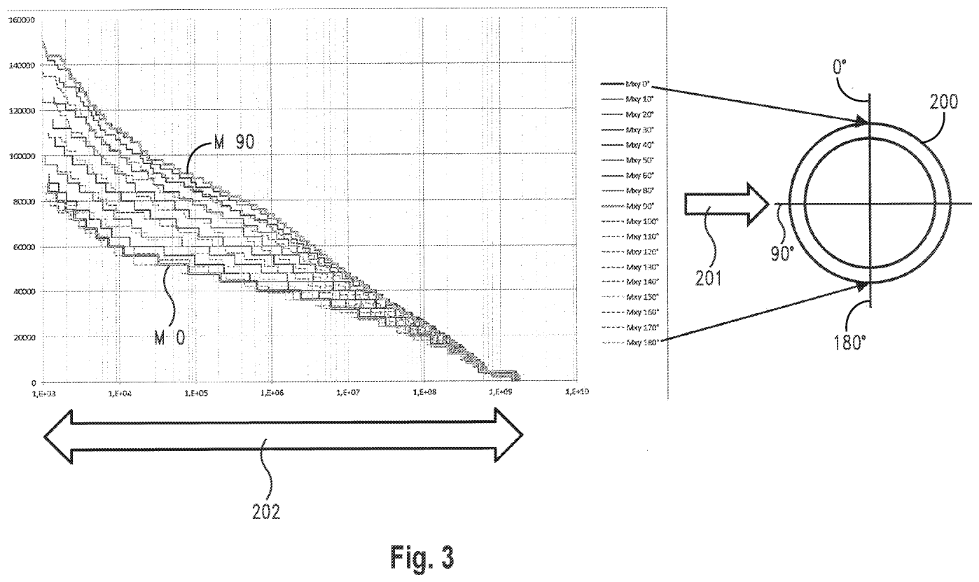

The right-hand side of FIG. 3 illustrates a cross section of a tower structure 200 with a plotted main load direction 201, which attacks at 90° in the variant illustrated here. The left-hand side illustrates load parameters in the form of load or design spectra, with the y-axis plotting the range of torque in kNm and the x-axis plotting the load changes. The arrow 202 indicates the design service life. Here, the upper load spectrum M90 corresponds to the design spectrum in the main load direction 201 at 90°. The lower design spectrum M0 corresponds to the design spectrum in the secondary load direction of 0°.

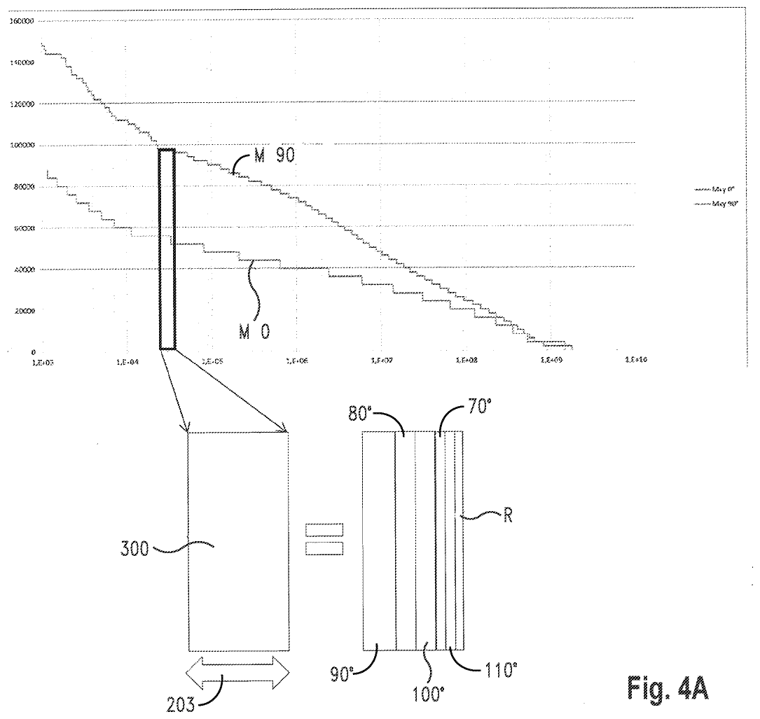

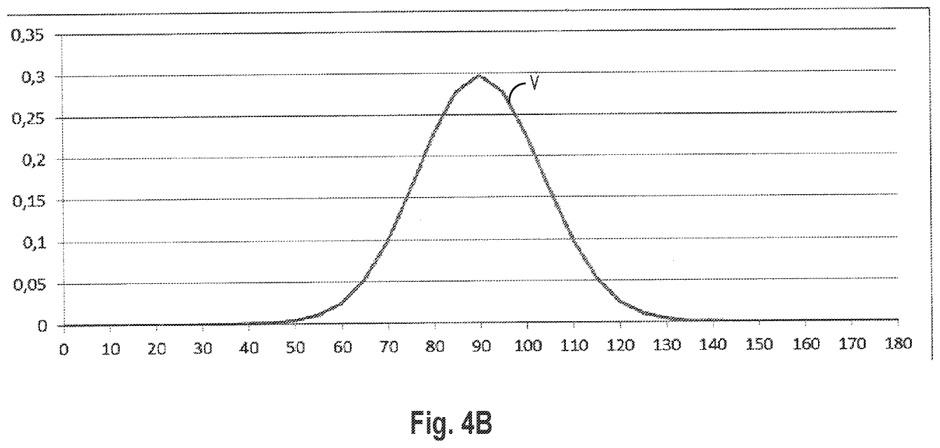

FIG. 4A illustrates only the upper load spectrum M90 and the lower load spectrum M0 from FIG. 3. A spectrum level 300 of the upper load spectrum M90 has been selected in exemplary fashion. The arrow 203 denotes the component of the spectrum level 300 of the design service life. If the load direction occurrence distribution V illustrated in FIG. 4B is now taken into account, the distribution of the spectrum level 300 among different load directions, illustrated bottom right in FIG. 4A, arises. What can be identified here is that the largest component can be recorded in the main load direction of 90° and the next largest components can be recorded in the adjacent secondary load directions of 80° and 100°, whereas already significantly smaller components can be recorded for the secondary load directions of 70° and 110°. The residual component R is distributed among the further secondary load directions. The distribution used to this end and illustrated in FIG. 4B is a Gaussian normal distribution with an expected value of 90° and a variance of 180°. The y-axis plots the frequency in the reference time period (the service life), while the horizontal axis plots the position on the circumference of the tower structure in degrees.

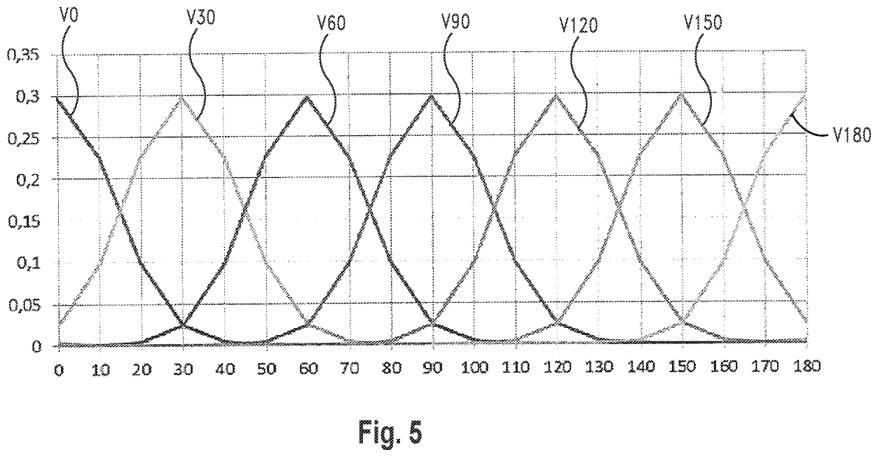

FIG. 5 illustrates distributions V0, V30, V60, V90, V120, V150, V180 of the occurrence of different load directions, in this case in 30° steps in a simplified fashion. Likewise, in a simplified fashion, this is based on the same Gaussian distribution with an expected value of 90° and a variance of 180°. However, different distributions for different load directions may also be assumed.

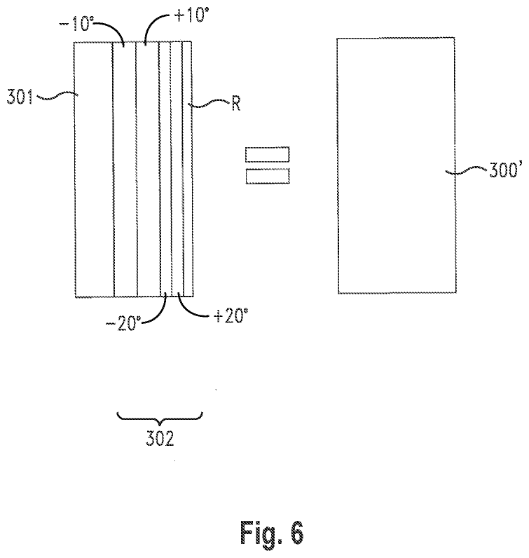

On the right-hand side, FIG. 6 shows a modified load parameter in the form of a modified spectrum level 300′ and, on the left-hand side, it shows the composition thereof. Here, 301 denotes the component that results from the own load direction of the load spectrum of the load level. 302 represents those components that result from the load spectra of the secondary load directions, which are arranged with an offset of +/−10° and +/−20° to the own load direction. The components offset by further degrees are combined under the remainder R.

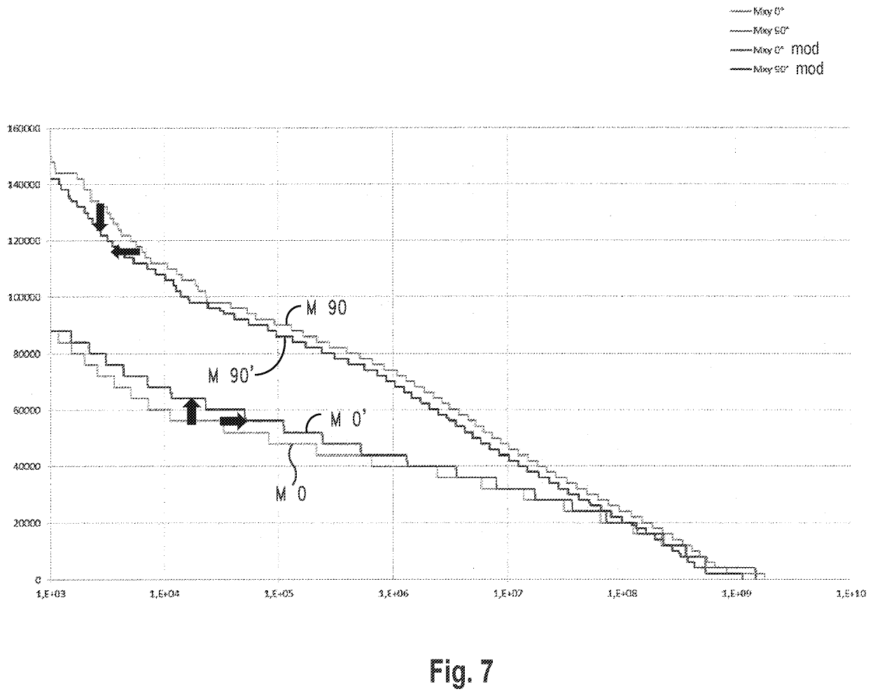

The results of the procedure are illustrated in exemplary fashion in FIG. 7. The load spectra M90 and M0 according to FIG. 7 correspond to the load spectra M90 and M0 illustrated in FIG. 3. Additionally, the modified load parameters in the form of the modified load spectra M90′ and M0′ are illustrated in FIG. 7. As may be identified and as is elucidated by the arrows, the procedure reduces the operating loads in the main load direction, whereas the operating loads in the secondary load direction are increased. Particularly when only the operating loads in the main load direction are used to design a tower structure, a significant design advantage consequently arises as a result of the method.

By taking account of the modified load parameter, it is also possible to substantiate a lengthened (residual) service life for already existing tower structures.

1. A method for identifying an operating load for a tower structure of a wind power installation, comprising:
determining a load parameter in a load direction;
determining a load direction occurrence distribution;
modifying the load parameter by the load direction occurrence distribution to generate a modified load parameter; and
identifying the operating load of the tower structure of the wind power installation based on the modified load parameter.

2. The method as claimed in claim 1, comprising:
dividing the load parameter according to the load direction occurrence distribution into load parameter components in different load directions.

3. The method as claimed in claim 2, comprising:
summing the load parameter components per load direction.

4. The method as claimed in claim 1, comprising at least one of the following steps:
estimating the load direction occurrence distribution;
determining the load direction occurrence distribution based on historical or measured load data; and
determining the load direction occurrence distribution based on a statistical distribution and/or an occurrence probability.

5. The method as claimed in claim 1, wherein a probability mass function underlies the load direction occurrence distribution.

6. The method as claimed in claim 1, comprising:
determining a plurality of load direction occurrence distributions for a respective plurality of different load directions, wherein the plurality of load direction occurrence distributions the same or different.

7. The method as claimed in claim 1, comprising:
determining a plurality of load parameters for a respective plurality of different load directions.

8. The method as claimed in claim 7, comprising:
determining the plurality of load parameters based on differences between the respective plurality of different load directions.

9. The method as claimed in claim 7, comprising:
determining the plurality of load parameters based on different values of the plurality of load parameters in the respective plurality of different load directions.

10. The method as claimed in claim 7, comprising:
determining the plurality of load parameters based on a distribution of values of the plurality of load parameters.

11. The method as claimed in claim 7, comprising:
determining the plurality of load parameters based on differences in wind speeds in the plurality of different load directions.

12. A method for determining a tower structure for a wind power installation, comprising:
determining an operating load for the tower structure by:
determining a load parameter in a load direction;
determining a load direction occurrence distribution;
modifying the load parameter by the load direction occurrence distribution to generate a modified load parameter; and
identifying the operating load based on the modified load parameter; and
designing the tower structure of the wind power installation based on the operating load.

13. A method for determining a service life of a tower structure of a wind power installation, comprising:
determining an operating load for the tower structure by:
determining a load parameter in a load direction;
determining a load direction occurrence distribution;
modifying the load parameter b the load direction occurrence distribution to generate a modified load parameter; and
identifying the operating load based on the modified load parameter; and
determining the service life of the tower structure based on the identified operating load.

14. The tower structure of the wind power installation having the load parameter for determining the tower structure determined according to the method as claimed in claim 1.

15. A wind power installation, comprising:
a tower having a tower structure; and
a nacelle arranged on the tower and including a rotor with at least one rotor blade, wherein the tower structure has an operating load determined by:
determining a load parameter in a load direction;
determining a load direction occurrence distribution;
modifying the load parameter b the load direction occurrence distribution to generate a modified load parameter; and
identifying the operating load of the tower structure of the wind power installation based on the modified load parameter.

16. The method as claimed in claim 1, wherein the operating load is a wind load.
